(19) United States
(12) Patent Application Publication
(10) Pub. No.: US 2024/0411829 A1
(43) Pub. Date: Dec. 12, 2024

(54) INTERACTION METHOD AND APPARATUS, COMPUTER DEVICE, AND STORAGE MEDIUM

(71) Applicant: Beijing Bytedance Network Technology Co., Ltd., Beijing (CN)

(72) Inventors: Shuangshuang JIANG, Beijing (CN); Junxin WU, Beijing (CN); Boyang LI, Beijing (CN)

(21) Appl. No.: 18/702,187

(22) PCT Filed: Dec. 2, 2022
(86) PCT No.: PCT/CN2022/136368

§ 371 Date: Apr. 17, 2024

(30) Foreign Application Priority Data
Dec. 31, 2021 (CN) 202111678997.2

(51) Int. Cl. G06F 16/957; G06F 16/9538

(52) U.S. Cl. CPC G06F 16/957; G06F 16/9538

(57) ABSTRACT

The present invention provides an interaction method, an interaction apparatus, a computer device, a computer readable storage medium, a computer program product, and a computer program. The method includes: receiving query information; determining query results corresponding to the query information; and receiving a browsing request for a first query result in the query results, displaying content information of the first query result, and displaying a jump identifier, the jump identifier being used for jumping to a page corresponding to a second query result having a preset position relationship with the first query result in the query results.

### CROSS-REFERENCE TO RELATED APPLICATION

This application claims the priority of China patent application with application number 202111678997.2 and application title “an interaction method and apparatus, computer device and storage medium”, filed in China Patent Office on Dec. 31, 2021, the entire content of which is incorporated herein by reference.

### TECHNICAL FIELD

The invention relates to the technical field of computer, in particular to an interaction method, an interaction apparatus, a computer device, a computer-readable storage medium, a computer program product and a computer program.

### BACKGROUND

With the development of Internet technology, the way of information inquiry through search engine has gradually become popular. In view of the search results of the existing search engines, if user needs to jump from the current detail page to the next detail page, he needs to close the current detail page and click Browse to the next detail page in the result list page of the search results. In this case, for the above search results, if the user needs to browse continuously, he needs to exit to the result list page repeatedly. Therefore, the existing browsing methods are cumbersome and easy to reduce the user's browsing experience.

### SUMMARY

The embodiment of the present disclosure at least provides an interaction method, an interaction apparatus, a computer device, a computer-readable storage medium, a computer program product and a computer program.

An embodiment of the present disclosure provides an interactive method, including:
receiving query information, wherein the query information includes description information of a question to be queried; determining a query result corresponding to the query information, wherein the query result includes a plurality of results matched with the question to be queried, and any two results are not related to each other; receiving a browsing request for a first query result among the query result, displaying content information of the first query result and displaying a jump identifier, wherein the jump identifier is used to jump to a page corresponding to a second query result having a preset positional relationship with the first query result among the query result.

In an optional embodiment, the jump identifier includes a first jump identifier and/or a second jump identifier, the first jump identifier is used to jump to a page corresponding to a second query result which is located before the first query result and has a preset positional relationship with the first query result among the plurality of results, and the second jump identifier is used to jump to a page corresponding to a second query result which is located after the first query result and has a preset positional relationship with the first query result among the plurality of results.

In an optional embodiment, the displaying a jump identifier includes:
determining a first display position in a display page of the content information, wherein the first display position includes a position located in an area below a central axis of the display page; displaying a floating jump button at the first display position, wherein the floating jump button is used to indicate the positional relationship between the first query result and the second query result among the plurality of results.

In an optional embodiment, the displaying a jump identifier includes:
displaying a target jump window at a bottom of a display page of the content information; displaying target information of the second query result in the target jump window, wherein the target information is used to represent a second key content of the second query result, the second key content is not completely identical to a first key content of the first query result, and the target information includes at least one of title information, at least part of abstract information and information source.

In an optional embodiment, the determining a query result corresponding to the query information includes:
acquiring initial query results of the query information, wherein the initial query results correspond to at least one category; filtering the initial query results of the at least one category based on a content similarity, and determining a filtered result of initial query results of each category as a query result of the category; wherein the displaying target information of the second query result in the target jump window includes: displaying the target information of the second query result in a category to which the first query result belongs or other categories in the target jump window.

In an optional embodiment, wherein the displaying a jump identifier includes:
displaying the jump identifier at a bottom of the display page in a case where it is detected that a web page corresponding to the first query result displayed in the display page has slid to the bottom of the display page.

In an optional embodiment, the target jump window includes an operation identifier for controlling a display state of the target jump window, and the method further includes:
controlling the target jump window to be folded down to a bottom of the display page in response to a triggering operation for the operation identifier; hiding the target information displayed in the target jump window, and switching a display state of the operation identifier to a preset state, wherein the operation identifier in the preset state is used for triggering to restore the target jump window to a unfold state on a display interface.

In an optional embodiment, the displaying a jump identifier includes:
acquiring a field content of a display field of the jump identifier, wherein the field content is used for indicating whether the jump identifier meets a display condition for displaying on the display page; displaying the jump identifier at a bottom of a display page of the content information in a case where it is determined that the jump identifier meets the display condition based on the field content.

In an optional embodiment, the method further includes:
receiving a triggering operation for the jump identifier; determining a page jump link corresponding to the jump identifier, and jumping to a page corresponding to the page jump link.

In an optional embodiment, the determining a query result corresponding to the query information includes:
determining a query keyword in the query information, wherein the query keyword includes a keyword associated with the question to be queried in the query information; querying initial query results matched with the query keyword in a network resource; filtering the initial query results based on a result relevance between the initial query results to obtain the query result.

In an optional embodiment, the filtering the initial query results based on a result relevance between the initial query results to obtain the query result includes:
extracting key information from each initial query result based on the query keyword, wherein the key information includes a query abstract and/or a query title; determining a result similarity between any two initial query results based on the key information of the any two initial query results; performing de-duplication processing on initial query results with the result similarity being greater than a preset threshold, and obtaining the query result after de-duplication.

An embodiment of the present disclosure also provides an interactive apparatus, including a receiving unit, a determining unit and the displaying unit. the receiving unit is configured to receive query information, wherein the query information includes description information of a question to be queried; the determining unit is configured to determine a query result corresponding to the query information, wherein the query result includes a plurality of results matched with the question to be queried, and any two results are not related to each other; and the displaying unit is configured to receive a browsing request for a first query result among the query result, display content information of the first query result and display a jump identifier, wherein the jump identifier is used to jump to a page corresponding to a second query result having a preset positional relationship with the first query result among the query result.

An embodiment of the present disclosure also provides a computer device including a processor, a memory and a bus, wherein the memory stores machine-readable instructions executable by the processor, the processor communicates with the memory through the bus when the computer device is running, and when the machine-readable instructions are executed by the processor, the steps in any one of the above embodiments are executed.

An embodiment of the present disclosure also provides a computer-readable storage medium, wherein a computer program is stored on the computer-readable storage medium, and the computer program, when executed by a processor, executes the steps in any one of the above embodiments.

An embodiment of the present disclosure also provides a computer program product carrying a program code, wherein instructions included in the program code are capable of executing the steps in any one of the above embodiments.

An embodiment of the present disclosure also provides a computer program, wherein the computer program, when executed by a processor, executes the steps in any one of the above embodiments.

According to the interactive method, apparatus, computer device and storage medium provided by the embodiment of the present disclosure, after determining a plurality of query results corresponding to the query information input by the user, the corresponding first query result can be browsed in response to the browsing request of the user, and the page corresponding to the second query result having a preset positional relationship with the first query result can be jumped through the jump identifier in the page. Compared with the current browsing mode for multiple search results, if a user has a continuous browsing demand, he needs to repeatedly exit to the result list page, the present disclosure can jump in the page corresponding to the query result through the jump identifier, thereby simplifying the browsing mode of the user and improving the browsing experience of the user.

In order to make the above objects, features and advantages of the present disclosure more obvious and easy to understand, the following is a detailed description of embodiments, with the attached drawings.

### BRIEF DESCRIPTION OF DRAWINGS

In order to explain the technical scheme of the embodiment of the present disclosure more clearly, the following will briefly introduce the drawings needed in the embodiment, which are incorporated into and constitute a part of this specification. These drawings show the embodiment in line with the present disclosure and together with the specification, serve to explain the technical scheme of the present disclosure. It should be understood that the following drawings only show some embodiments of the present disclosure, so they should not be regarded as limiting the scope. For ordinary people in the field, other related drawings can be obtained according to these drawings without creative work.

FIG. 1 shows a flowchart of an interaction method provided by an embodiment of the present disclosure.

FIG. 2a shows a schematic diagram of a display mode of a jump identifier in a display interface provided by an embodiment of the present disclosure.

FIG. 2b shows a schematic diagram of another display mode of a jump identifier in a display interface provided by an embodiment of the present disclosure.

FIG. 3a shows a schematic diagram of a display form of a target jump window provided by an embodiment of the present disclosure.

FIG. 3b shows a schematic diagram of another display form of the target jump window provided by the embodiment of the present disclosure.

FIG. 3c shows a schematic diagram of the folding display mode of the target jump window provided by the embodiment of the present disclosure;

FIG. 4 shows a schematic diagram of an interactive apparatus provided by an embodiment of the present disclosure;

FIG. 5 shows a schematic diagram of a computer device provided by an embodiment of the present disclosure.

### DETAILED DESCRIPTION

In order to make the purpose, technical scheme and advantages of the embodiment of the disclosure clear, the technical scheme in the embodiment of the disclosure will be described clearly and completely with the attached drawings. Obviously, the described embodiments are only a part of the embodiments of the disclosure, but not all embodiments. The components of the embodiments of the present disclosure generally described and illustrated in the drawings herein may be arranged and designed in various different configurations. Therefore, the following detailed description of the embodiments of the disclosure provided in the accompanying drawings is not intended to limit the scope of the claimed disclosure, but merely represents selected embodiments of the disclosure. Based on the embodiments of the present disclosure, all other embodiments obtained by those skilled in the art without creative work belong to the scope of protection of the present disclosure.

It should be noted that similar symbols and letters indicate similar items in the following drawings, so once an item is defined in one drawing, it does not need to be further defined and explained in subsequent drawings.

In this paper, the term “and/or” only describes an associative relationship, which means that there can be three kinds of relationships, for example, A and/or B, which can mean that A exists alone, A and B exist at the same time, and B exists alone. In addition, the term “at least one” in this paper means any one or any combination of at least two of a variety, for example, including at least one of A, B or C, and can mean including any one or more elements selected from the set of A, B and C.

It is found that for the search results of existing search engines, if user needs to jump from the current detail page to the next detail page, the user needs to close the current detail page and click to browse the next detail page in the result list page of the search results. In this case, for the above search results, if the user needs to browse continuously, the user needs to exit to the result list page repeatedly. Therefore, the existing browsing methods are cumbersome and easy to reduce the user's browsing experience.

Based on the above research, the present disclosure provides an interactive method. In the embodiment of the present disclosure, after determining a plurality of query results corresponding to the query information input by the user, the user can be guided to jump in the page corresponding to the query results through the jump identifier, so that the user can view other query results without exiting to the result list page, thereby simplifying the browsing mode of the user and improving the browsing experience of the user.

In order to facilitate the understanding of this embodiment, firstly, an interactive method disclosed in this embodiment of the disclosure is introduced in detail. The executing subject of the interactive method provided in this embodiment of the disclosure is generally a computer device with certain computing power, which includes, for example, a terminal device, a server or other processing device. In some possible implementations, the interactive method can be realized by a processor calling computer-readable instructions stored in a memory.

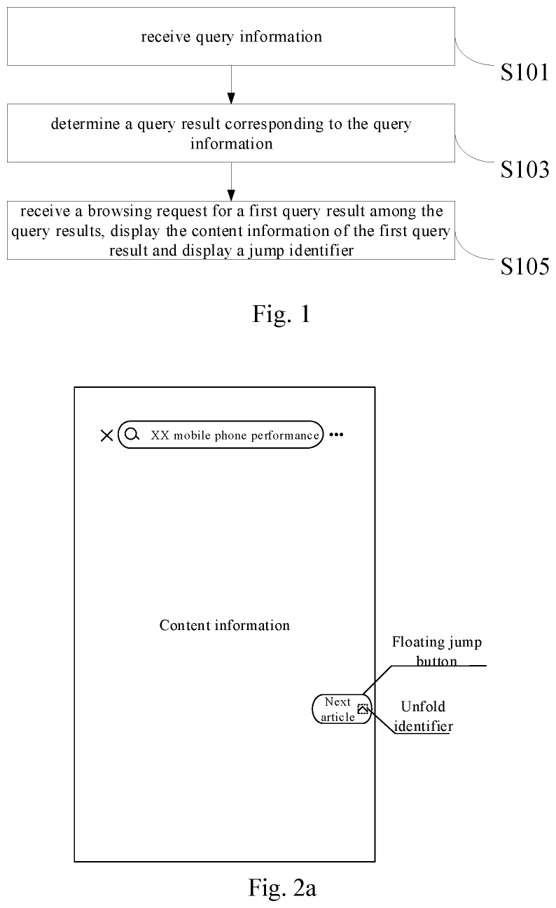

Referring to FIG. 1, it is a flowchart of an interaction method provided by an embodiment of the present disclosure, which includes steps S101˜S105, wherein

S101: receiving query information, wherein the query information includes the description information of the question to be queried.

In the embodiment of the present disclosure, after receiving the above query information, the description information of the question to be queried contained in the query information can be determined. Wherein the description information can be a query subject in the query information and/or a subject description keyword about the query subject.

For example, the question to be inquired contained in the above information can be: the performance of XX brand mobile phone. Here, the query subject of the question to be queried can be “XX brand mobile phone”, and the subject description keyword of the query subject can be “performance”.

In addition, the above query information can also be classified according to the description information of the question to be queried. For example, the question to be queried can be divided into a general-demand question with continuous browsing requirement and a directional-demand question.

Specifically, when determining the description information of the question to be queried, keywords of the type information contained in the question to be queried can also be identified, so as to determine the type of the information to be queried. For example, when the question to be queried contains keywords such as “how”, “what”, it can be determined that the question to be queried is called the general-demand question.

S103, determining a query result corresponding to the query information, wherein the query result contains a plurality of results matched with the question to be queried, and any two results are not related to each other.

In the embodiment of the present disclosure, when determining the query result corresponding to the above query information, the determination can be made according to the description information of the question to be queried. Specifically, the description information of the question to be queried includes the query subject and/or the subject description keyword.

Here, for example, the information to be queried includes the query subject and the subject description keyword. When determining the above query results, the initial query results including the query subject and the subject description keyword can be determined at first.

Then, according to the content in the initial query result, the initial query result can be compared, so as to determine the initial query result whose content relevance is lower than the similarity requirement, and determine the initial query result whose relevance is lower than the similarity requirement as a plurality of results matching the question to be queried (i.e., query results corresponding to the above query information).

Here, when comparing the initial query results, the comparison can be made according to the contents in the initial query results, and the comparison can also be made according to part of the contents in the initial query results. For example, the part of the contents can be the query titles and/or the query abstracts of the initial query results.

It should be understood that any two of the query results determined here are not related to each other, that is, the core contents of any two of the query results are not exactly the same, thus reducing the number of users browsing the query results with duplicate contents.

S105: receiving a browsing request for a first query result among the query results, displaying the content information of the first query result, and displaying a jump identifier, wherein the jump identifier is used to jump to a page corresponding to a second query result having a preset positional relationship with the first query result among the query results.

In an embodiment of the present disclosure, after the query result is determined, a plurality of results contained in the query result can be returned to the terminal and displayed on the display interface of the terminal, wherein the user can browse the query result on the display interface, so as to determine the first query result that the user wants to browse.

Here, after the user's browsing request for the first query result is detected, the content information in the first query result can be displayed through the page corresponding to the first query result, and the jump identifier can be displayed in the page corresponding to the first query result, wherein the jump identifier is used for instructing the user to jump to the page corresponding to the second query result.

Specifically, the query result may be a query list containing multiple results matching the question to be queried. When determining the second query result indicated by the jump identifier, the order of the multiple results on the query list can be obtained. Furthermore, according to the order, a second query result having a preset positional relationship with the first query result is determined, wherein the preset positional relationship can be a result adjacent to the first query result. For example, the second query result can be the previous result or the next result of the first query result.

From the above description, it can be seen that in the embodiment of the present disclosure, after determining a plurality of query results corresponding to the query information input by the user, the user can be guided to jump in the page corresponding to the query result through the jump identifier, so that the user can view other query results without repeatedly exiting the result list page, thereby simplifying the browsing mode of the user and improving the browsing experience of the user.

In an optional embodiment, the above step S103 of determining the query result corresponding to the query information specifically includes the following processes:
(1) determining the query keyword in the query information, wherein the query keyword is the keyword associated with the question to be queried in the query information;
(2) querying the initial query result matched with the query keyword in the network resource;
(3) the initial query results are filtered based on the result relevance between the initial query results to obtain the query results.

In the embodiment of the present disclosure, the query keyword corresponding to the query information include at least one. For example, when determining the query keyword in the query information, the query keyword can be the query subject and/or the subject description keyword of the question to be queried.

In addition, the query keyword can also be a keyword similar to the query subject and/or subject description keyword. For example, the query subject is “tangerine” and the query keyword can also be “orange”.

After the query keyword is determined, the initial query results that match the query keyword can be determined in the network resource.

In an optional embodiment, the network resource that hit all the query keywords of the query information can be determined as the initial query results. In another optional embodiment, the network resource that hit at least one query keyword can also be determined as the initial query result.

It should be noted that after the initial query results are determined, the initial query results can be filtered based on the relevance between the initial query results, so as to obtain the above query results.

Specifically, the content of the initial query results can be obtained, and the key content corresponding to the content of each initial query result can be extracted through the trained reading comprehension model, and each initial query result can be filtered based on the key content, wherein the key content is used to represent the key information of each initial query result.

Here, when filtering the initial query results, the relevance between the initial query results can be compared, so that the initial query results can be filtered by the relevance.

In practice, the similarity between the key contents of any two initial query results can be determined, so as to determine the relevance between the two initial query results according to the similarity.

In the embodiment of the present disclosure, after determining the initial query result, the initial query result can be displayed on the display interface through the search result page, and after detecting the user's triggering operation for the initial query result in the search result page, it is judged whether the initial query result corresponding to the triggering operation hits the above query result.

When the initial query result corresponding to the triggering operation hits the above query result, a detailed page can be created in the search result page, and the above query result can be displayed through the detailed page, so that the user can select the first query result that the user wants to browse in the detailed page.

Optionally, after the initial query result is determined, the initial query result can be filtered to obtain the query result. Then, the query result can be displayed through the search result page, and the user's triggering operation for the first query result in the query result can be detected.

From the above description, it can be seen that by determining the initial query results according to the query keyword in the query information and filtering the initial query results, the results with high relevance in the initial query results can be filtered, so as to obtain unrelated query results. Through this processing mode, the browsing efficiency of user can be improved and the results with high repetition can be avoided.

In an optional embodiment, the above step of filtering the initial query results based on the result relevance between the initial query results to obtain the query results, specifically includes the following process:
(1) extracting the key information from each initial query result based on the query keyword, wherein the key information includes a query abstract and/or a query title;
(2) determining the result similarity between any two initial query results based on the key information of any two initial query results;
(3) performing de-duplication processing on the initial query result with the similarity of the results being greater than a preset threshold, and obtaining the query result after de-duplication.

In an embodiment of the present disclosure, when extracting the key information in each initial query result, the query title in the initial query result can be obtained first.

Specifically, in an optional embodiment, if the initial query result does not contain the query title, the title corresponding to the initial query result can be extracted according to the query keyword. Here, the target sentence containing the largest number of query keywords in the initial query result can be used as the query title of the initial query result, or refined based on the target sentence, so as to obtain the query title of the initial query result.

After the query title is determined, the query abstract corresponding to the initial query result can be extracted according to the query title.

In another optional embodiment, if the initial query result does not contain the above query title, the corresponding query abstract can also be extracted from the initial query result. Specifically, when the genre of the initial query result is the preset article genre, the abstract position of the initial query result can be directly located, and the abstract in the abstract position can be extracted as the query abstract of the initial query result.

In addition, when the initial query result does not contain an abstract, the query abstract corresponding to the initial query result can be extracted by the above query keyword. Specifically, the target segment containing the above query keyword in the initial query result can be determined, and the target segment can be used as the query abstract of the initial query result, or refined based on the target segment, so as to obtain the query abstract of the initial query result.

After determining the key information in each initial query result, the similarity between any two initial query results can be determined based on the key information of any two initial query results. Specifically, the similarity between the two initial query results can be determined based on the query abstracts and/or query titles of any two initial query results.

Here, an example is given to illustrate how to determine the similarity between any two initial query results based on the query abstracts and the query titles of the any two initial query results. Specifically, a first similarity between query titles of two initial query results and a second similarity between query abstracts of the two initial query results can be determined.

After determining the first similarity and the second similarity, a preset threshold can be obtained, and the first similarity and the second similarity are compared with the preset threshold respectively. When it is determined that the first similarity or the second similarity of the two initial query results is higher than the preset threshold, it is determined that the two initial query results are duplicate query results.

After comparing the initial query results, at least one duplicate query result in the initial query results can be determined, wherein each duplicate query result contains multiple initial query results. Then, each duplicate query can be processed to get the query results.

Specifically, when the duplicate query results are processed, the heat identification of each initial query result in the duplicate query results can be obtained, and the initial query result with the highest heat in the duplicate query results can be determined as the query result in the duplicate query results.

From the above description, it can be seen that the initial query result determined according to the query information can be de-duplicated to obtain the query result, which can improve the readability of the query result, reduce the possibility of user seeing the query result with high content repetition, and further improve the browsing experience of user.

In an optional embodiment, the jump identifier includes a first jump identifier and/or a second jump identifier. The first jump identifier is used to jump to a page corresponding to a second query result which is located before the first query result and has a preset positional relationship with the first query result among the plurality of results, and the second jump identifier is used to jump to a page corresponding to a second query result which is located behind the first query result and has a preset positional relationship with the first query result among the plurality of results.

Specifically, the jump identifier may include a first jump identifier and/or a second jump identifier, wherein the display forms of the first jump identifier and the second jump identifier may be the different or different, which is not specifically limited in this disclosure, as long as it can be realized.

Here, the first jump identifier is used to jump to a page corresponding to a second query result which is located before the first query result among the above results, wherein the second query result and the first query result have a preset positional relationship.

Specifically, the preset positional relationship may be the previous result located before the first query result among the above results. Optionally, the preset positional relationship can also be the nth results located before the first query result among the above-mentioned multiple results (n is the preset jump number), wherein the user can jump to any one of the n results through the first jump identifier.

Similarly, the second jump identifier is used to jump to a page corresponding to a second query result after the first query result among the plurality of results, wherein the second query result and the first query result have a preset positional relationship.

Specifically, the preset positional relationship may be the next result located behind the first query result among the above results. Optionally, the preset positional relationship can also be the next nth result located behind the first query result among the above-mentioned multi-turn results, wherein the user can jump to any one of the n results through the first jump identifier.

It should be noted that the forms of the first jump identifier and the second jump identifier may be different. For example, when the jump identifier is in the form of a button, the text information contained in the first jump identifier may be “the previous one” and the text information contained in the second jump identifier may be “the next one”.

As can be seen from the above description, in the embodiment of the present disclosure, the jump identifier can include two forms, namely, the first jump identifier and the second jump identifier, and the user can perform forward jump and the latter backward jump in a plurality of results through the two forms of jump identifiers, thereby improving the flexibility of jumping and improving the browsing experience of the user.

In an optional embodiment, in step S105, the jump identifier is displayed, specifically including the following process:
(1) determining a first display position in a display page of the content information, wherein the first display position is a position located in an area below the central axis of the display page;
(2) displaying a floating jump button at the first display position, the floating jump button is used to indicate the positional relationship between the first query result and the second query result among the multiple results.

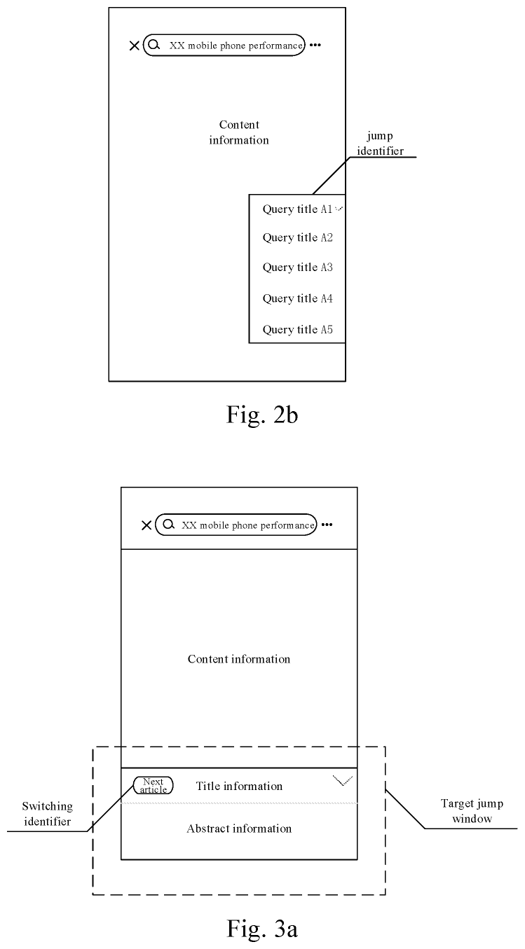

In the embodiment of the present disclosure, when the content information of the first query result is displayed on the display page, the first display position in the display page for displaying the jump identifier can also be determined, wherein the first display position can be a preset display position of the jump identifier, as shown in FIG. 2a, which is a display mode of the jump identifier in the display interface, and the jump identifier is a floating jump button.

Here, the user can also unlock the floating jump button by long press etc. and move the floating jump button to other position. Here, the user can also jump to the page corresponding to the second query result by clicking the floating jump button.

In addition, as shown in FIG. 2b, it is another display mode of the jump identifier in the display interface, in which the user can unfold the floating jump button by triggering the unfold identifier in the floating jump button as shown in FIG. 2a, so as to display all the second query results that can jump to. Among them, the unfolded floating jump button can also simultaneously display the query title corresponding to each second query result.

From the above description, it can be seen that the above-mentioned jump identifier can be a display form of a floating jump button, and the user can jump to the page corresponding to the second query result by triggering the floating jump button, thus facilitating the user to jump among multiple results, and the floating jump identifier can be adapted to the user's unlocking operation to adjust the position, thereby reducing the possibility of shielding the content information and providing the user with a better browsing vision on the basis of facilitating the jump.

In an optional embodiment, in step S105, displaying the jump identifier specifically includes the following steps:
(1) displaying a target jump window at the bottom of the display page of the content information;
(2) displaying the target information of the second query result in the target jump window, wherein the target information is used to represent the second key content of the second query result, which is not completely the same as the first key content of the first query result, and the target information includes at least one of the following: title information, at least part of abstract information and information source.

In the embodiment of the present disclosure, the jump identifier can also be a display form of a target jump window, and the target jump window can be displayed at the bottom of the display page, wherein the target jump window can be used to display the second key content of a second query result that has a preset positional relationship with the first query result, for example, to display the second key content of a second query result that is located in the next one among a plurality of results. Here, the second key content includes at least one of title information, at least part of abstract information and information source.

It should be noted that the target information of the second query result may include at least some key contents in the second query result. When the display form of the target window is different, the content contained in the target information can be different.

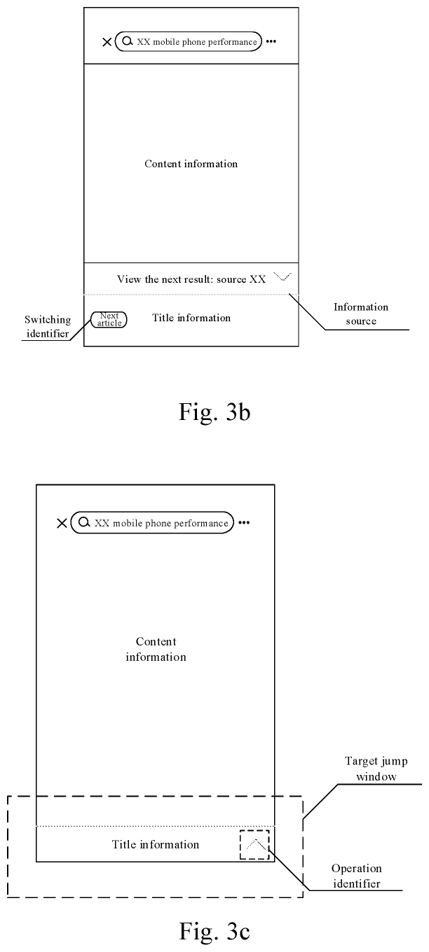

Specifically, a display form of the target jump window is shown in FIG. 3a, wherein the target information displayed in the target jump window is the title information of the second query result and/or at least part of the abstract information.

In addition, another display form of the target jump window is shown in FIG. 3b, wherein the target information displayed in the target jump window is the title information and information source of the second query result.

It should be noted that when the target information of the second query result is displayed in the target jump window, it can also be displayed in different display forms, and the content of the target information contained in the target jump window can also be different from the above two display forms, which is not specifically limited in present disclosure.

In an embodiment of the present disclosure, a switching identifier (as shown in FIGS. 3a and 3b, for example) can also be displayed in the target jump window, and the user can switch the corresponding second query result in the target jump window by triggering the switching identifier.

Specifically, after detecting the user's triggering operation for the switching identifier, the second query result corresponding to the switching identifier can be determined, and the target information corresponding to the second query result can be obtained and displayed in the target jump window.

Therefore, through the switching identifier, the user can browse the target information of a plurality of second query results through the target jump window in the page corresponding to the first query result, thereby shortening the browsing path of the user and improving the browsing efficiency of the user.

From the above description, it can be seen that in the embodiment of the present disclosure, the jump identifier can also be a display form of the target jump window, so as to display more contents of the second query result to the user through the target jump window, thereby facilitating the user to browse part of the contents of the second query result in the display interface of the first query result, and further improving the browsing experience of the user.

In an optional embodiment, the above step S103 of determining the query result corresponding to the query information, specifically includes the following process:
acquiring an initial query result of the query information, wherein the initial query results correspond to at least one category; filtering the initial query results of a category based on the content similarity, and determining the filtered results of the initial query results of each category as the query results of the category;
displaying the target information of the second query result in the target jump window includes the following steps:
displaying the target information of the second query result in the category to which the first query result belongs or other categories in the target jump window.

In an embodiment of the present disclosure, the jump window may also display the category to which the first query result belongs, or the target information of the second query result of other categories.

Here, first of all, it is necessary to determine at least one category corresponding to the initial query results, and filter the initial query results corresponding to the same category to obtain the query result corresponding to each category, wherein each category can correspond to at least one query result. The filtering method for the initial query results of each category is as described above, and will not be described here.

After determining the query result corresponding to each of the above categories, the query results can also be filtered to determine other categories different from the category of the first query result. After that, the target information of the second query result of the category to which the first query result belongs or other categories can be displayed in the target jump window.

Through the above processing methods, various types of query results can be displayed for user, thus further simplifying the browsing operation of user.

In an optional embodiment, in step S105, the displaying the jump identifier specifically includes the following process:

When it is detected that the web page corresponding to the first query result displayed in the display page has slid to the bottom of the page, the jump identifier is displayed at the bottom of the display page.

In the embodiment of the present disclosure, the jump identifier can also be displayed in a condition-triggered manner, wherein it can be triggered by a bottoming condition. For example, if it is detected that the web page corresponding to the first query result in the display page has slid to the bottom of the page, the trigger condition of the jump identifier is determined to be met.

Specifically, when the user browses the web page corresponding to the first query result, the content information displayed on the web page can be pulled down through the progress bar set on the side of the web page. When the progress bar reaches the bottom, it is determined that the web page has slipped to the bottom of the page, thus determining that the trigger condition of the jump identifier is met.

From the above description, it can be seen that in the embodiment of the present disclosure, when it is detected that the web page corresponding to the first query result has slid to the bottom of the page, the jump identifier can be displayed at the bottom of the display page, thus reducing the occlusion or cover of the jump identifier on the content information of the first query result and ensuring the browsing experience of the user.

In an optional embodiment, in step S105, the displaying the jump identifier specifically includes the following process:
(1) acquiring the field content of the display field of the jump identifier, wherein the field content is used to indicate whether the jump identifier meets the display conditions for displaying on the display page;
(2) When it is determined that the jump identifier meets the display condition based on the field content, the jump identifier is displayed at the bottom of the display page of the content information.

In an embodiment of the present disclosure, a display field can also be set for the jump identifier, wherein the user can determine whether to show the jump identifier by setting the field content of the display field.

Specifically, when it is detected that the user is browsing the first query result, the field content of the display field of the jump identifier can be obtained at first, and it is determined whether the jump identifier is allowed to be displayed according to the field content.

After it is determined according to the field content of the above display field that the jump identifier is allowed to be displayed, the content in the jump identifier can be determined, and the jump identifier can be displayed at the designated position of the display page.

From the above description, it can be seen that in the embodiment of the present disclosure, the user can decide whether to show the jump identifier by setting the display field of the jump identifier, so as to better meet the user's use requirements.

In an optional embodiment, in the case that the target jump window contains an operation identifier for controlling the display state of the target jump window, the method includes the following steps:
(1) controlling the target jump window to be folded down to the bottom of the display page in response to the triggering operation for the operation identifier;
(2) hiding the target information displayed in the target jump window, and switching the display state of the operation identifier to a preset state, wherein the operation identifier in the preset state is used for triggering to restore the target jump window to a unfold state on the display interface.

In an embodiment of the present disclosure, an operation identifier can also be set in the target jump window, and the operation identifier is used to unfold or close the target jump window. For example, the operation identifier can be a folding/unfolding identifier, wherein the folding/unfolding identifier is shown in FIGS. 3a and 3b.

Here, take FIG. 3a as an example, wherein the folding/unfolding identifier includes two display states of folding and unfolding, the folding state as shown in FIG. 3a (indicating that the target jump window can be folded by triggering the identifier in the folding state at the current moment), and the folding and displaying mode of the target jump window is shown in FIG. 3c after the operation identifier in the folding state is triggered by triggering operation, wherein the target information in FIG. 3c is in a hidden state. The display state of the operation identifier changes to the unfolding state (indicating that the target jump window can be unfolded by triggering the identifier in the unfolding state at the current moment), that is, the above preset state.

Here, the user can trigger the operation identifier in the preset state, so as to restore the target display window to the display state.

As can be seen from the above description, in the embodiment of the present disclosure, the user can fold or display the target jump window by operating the identifier, thereby further reducing the occlusion of the target jump window on the content information of the first query result and ensuring the browsing experience of the user.

In an optional embodiment, on the basis of the embodiment corresponding to FIG. 1, the method includes the following steps:
(1) receiving a triggering operation for the jump identifier;
(2) determine the page jump link corresponding to the jump identifier and jump to the page corresponding to the page jump link.

In the embodiment of the present disclosure, after receiving the triggering operation for the jump identifier, the page jump link of the second query result corresponding to the jump identifier can be obtained, and whether the access authority of the page jump link exists can be judged.

When the jump authority of the page jump link is determined, the page corresponding to the page jump link can be opened, and the content information of the second query result can be displayed through the page. When it is determined that there is no jump permission for the above-mentioned page jump link, the jump failure identifier can be displayed in the display page.

It should be noted that the page jump between different applications can be realized through the above jump identification, wherein the different applications here should be applications with mutual access rights.

From the above description, it can be seen that in the embodiment of the present disclosure, the page jump corresponding to the second query result can be realized through the page jump link corresponding to the jump identifier, so that the page jump between the same application and different applications is realized, and the application scope of the scheme is improved.

To sum up, in the embodiments of the present disclosure, after determining a plurality of query results corresponding to the query information input by the user, the user can be guided to jump in the page corresponding to the query results through the jump identifier, so that the user can view other query results without repeatedly exiting to the result list page, thereby simplifying the browsing mode of the user and improving the browsing experience of the user.

It can be understood by those skilled in the art that in the above-mentioned method of specific embodiments, the writing order of each step does not mean strict execution order and constitutes any limitation on the implementation process, and the specific execution order of each step should be determined according to its function and possible internal logic.

Based on the same inventive concept, an embodiment of the present disclosure also provides an interactive apparatus corresponding to the interactive method. Since the principle of solving problems by the apparatus in the embodiment of the present disclosure is similar to the above-mentioned interactive method in the embodiment of the present disclosure, the implementation of the apparatus can refer to the implementation of the method, and the repetition is not repeated here.

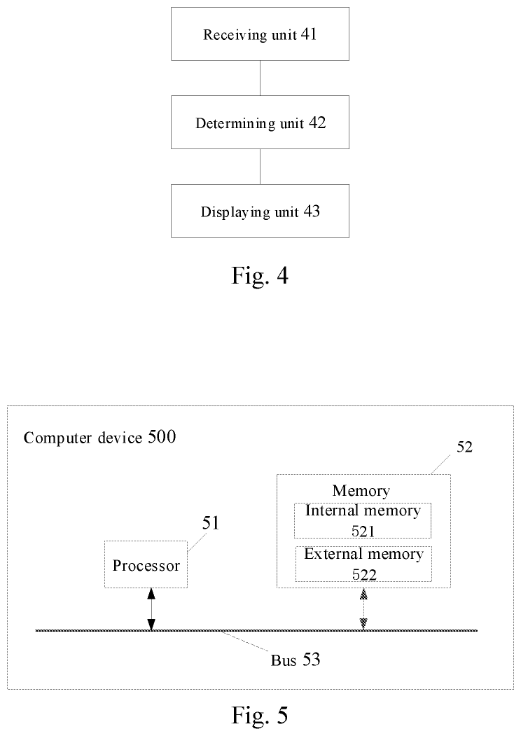

Referring to FIG. 4, it is a schematic diagram of an interactive apparatus provided by an embodiment of the present disclosure, which includes a receiving unit 41, a determining unit 42, and a displaying unit 43.

A receiving unit 41 is configured to receive query information, wherein the query information contains the description information of the question to be queried.

A determining unit 42 is configured to determine a query result corresponding to the query information, wherein the query result contains a plurality of results matched with the question to be queried and any two results are not related to each other.

A displaying unit 43 is configured to receive a browsing request for a first query result among the query results, display content information of the first query result, and display a jump identifier, wherein the jump identifier is used to jump to a page corresponding to a second query result having a preset positional relationship with the first query result among the query results.

In the embodiment of the present disclosure, after determining a plurality of query results corresponding to the query information input by the user, the user can be guided to jump in the page corresponding to the query results through the jump identifier, so that the user can view other query results without repeatedly exiting to the result list page, thereby simplifying the browsing mode of the user and improving the browsing experience of the user.

In a possible embodiment, the jump identifier includes a first jump identifier and/or a second jump identifier. The first jump identifier is used to jump to a page corresponding to a second query result which is located before the first query result and has a preset positional relationship with the first query result among the plurality of results, and the second jump identifier is used to jump to a page corresponding to a second query result which is located after the first query result and has a preset positional relationship with the first query result among the plurality of results.

In one possible embodiment, the displaying unit 43 is further used for:
determining a first display position in a display page of the content information, wherein the first display position is a position located in an area below the central axis of the display page; displaying a floating jump button at the first display position, the floating jump button is used to indicate the positional relationship between the first query result and the second query result among the multiple results.

In one possible embodiment, the displaying unit 43 is further used for:
displaying a target jump window at the bottom of the display page of the content information; displaying the target information of the second query result in the target jump window, wherein the target information is used to represent the second key content of the second query result, which is not completely the same as the first key content of the first query result, and the target information includes at least one of the following: title information, at least part of abstract information and information source.

In a possible embodiment, the determining unit 42 is further configured for:
acquiring an initial query result of the query information, wherein the initial query result corresponds to at least one category; filtering the initial query results of a category based on the content similarity, and determining the filtered results of the initial query results of each category as the query results of the category, wherein the displaying unit 43 is further configured to display the target information of the second query result in the category to which the first query result belongs or other categories in the target jump window.

In one possible embodiment, the displaying unit 43 is further used for:
when it is detected that the web page corresponding to the first query result displayed in the display page has slid to the bottom of the page, the jump identifier is displayed at the bottom of the display page.

In a possible embodiment, the target jump window contains an operation identifier for controlling the display state of the target jump window, and the interactive apparatus is further used for:
controlling the target jump window to be folded down to the bottom of the display page in response to the triggering operation for the operation identifier, hiding the target information displayed in the target jump window, and switching the display state of the operation identifier to a preset state, wherein the operation identifier in the preset state is used for triggering to restore the target jump window to a display or unfold state on the display interface.

In one possible embodiment, the displaying unit 43 is further used for:
acquiring the field content of the display field of the jump identifier, wherein the field content is used for indicating whether the jump identifier meets the display conditions for displaying on the display page; displaying the jump identifier at the bottom of the display page of the content information in a case where it is determined that the jump identifier meets the display condition based on the field content.

In a possible embodiment, the determining unit 42 is further configured for:
receiving a triggering operation for the jump identifier, determining a page jump link corresponding to the jump identifier, and jumping to a page corresponding to the page jump link.

In a possible embodiment, the determining unit 42 is further configured for:
determining query keywords in the query information, wherein the query keywords are keywords associated with the query to be queried in the query information; querying an initial query result matched with the query keywords in a network resource; filtering the initial query results based on the result relevance between the initial query results to obtain the query results.

In one possible embodiment, the displaying unit 43 is further used for:
extracting key information from each initial query result based on the query keywords, wherein the key information includes a query abstract and/or a query title; determining a result similarity between any two initial query results based on the key information of the any two initial query results; performing de-duplication processing on the initial query result with the result similarity being greater than a preset threshold, and obtaining the query result after de-duplication.

For the description of the processing flow of each unit in the apparatus and the interaction flow between each unit, please refer to the relevant description in the above method embodiments, and will not be described in detail here.

Corresponding to the interaction method in FIG. 1, an embodiment of the present disclosure further provides a computer device 500, as shown in FIG. 5, which is a structural schematic diagram of the computer device 500 provided for an embodiment of the present disclosure, including:

A processor 51, a memory 52, and a bus 53, wherein the memory 52 is used for storing execution instructions, the memory 52 includes the internal memory 521 and the external memory 522. The internal memory 521 here is also called internal memory, which is used to temporarily store the operation data in the processor 51 and the data exchanged with external memory 522 such as hard disk. The processor 51 exchanges data with the external memory 522 through the internal memory 521, and when the computer device 500 is running, the processor 51 communicates with the memory 52 through the bus 53, so that the processor 51 executes the following instructions:
receiving query information, wherein the query information contains the description information of the question to be queried;
determining a query result corresponding to the query information, wherein the query result contains a plurality of results matched with the question to be queried, and any two results are not related to each other;
receiving a browsing request for a first query result among the query results, displaying the content information of the first query result and displaying a jump identifier, wherein the jump identifier is used to jump to a page corresponding to a second query result having a preset positional relationship with the first query result among the query results.

The embodiment of the present disclosure also provides a computer-readable storage medium, on which a computer program is stored, and when the computer program is executed by a processor, the steps of the interactive method described in the above method embodiment are executed, wherein the storage medium can be a volatile or nonvolatile computer-readable storage medium.

The embodiment of the present disclosure also provides a computer program product, which carries a program code, and the program code includes instructions that can be used to execute the steps of the interactive method described in the above-mentioned method embodiment. For details, please refer to the above-mentioned method embodiments, which are not repeated here.

The embodiment of the present disclosure also provides a computer program, wherein the computer program, when executed by a processor, executes the steps of the interactive method described in the above-mentioned method embodiments. For details, please refer to the above-mentioned method embodiments, and the details are not repeated here.

For example, the above computer program product can be realized by hardware, software or their combination. In one optional embodiment, the computer program product is embodied as a computer storage medium, and in another optional embodiment, the computer program product is embodied as a software product, such as a software development kit (SDK) or the like.

It can be clearly understood by those skilled in the art that for the convenience and conciseness of description, the specific working process of the system and apparatus described above can refer to the corresponding process in the aforementioned method embodiments, and will not be repeated here. In several embodiments provided by this disclosure, it should be understood that the disclosed systems, apparatuses and methods can be realized in other ways. The device embodiments described above are only schematic. For example, the division of the units is only a logical function division, and there may be another division method in actual implementation. For example, multiple units or components may be combined or integrated into another system, or some features may be ignored or not implemented. On the other hand, the mutual coupling or direct coupling or communication connection shown or discussed can be indirect coupling or communication connection through some communication interfaces. The indirect coupling or communication connection of apparatuses or units can be in electrical, mechanical or other forms.

The units described as separate components may or may not be physically separated, and the components displayed as units may or may not be physical units, that is, they may be located in one place or distributed to multiple network units. Some or all of the units can be selected according to actual needs to achieve the purpose of this embodiment.

In addition, each functional unit in each embodiment of the present disclosure may be integrated into one processing unit, or each unit may exist physically alone, or two or more units may be integrated into one unit.

If the functions are realized in the form of software functional units and sold or used as independent products, they can be stored in a processor-executable nonvolatile computer-readable storage medium. Based on this understanding, the technical solution of the present disclosure can be embodied in the form of a software product, which is stored in a storage medium and includes several instructions to make a computer device (which can be a personal computer, a server, a network device, etc.) execute all or part of the steps of the method described in various embodiments of the present disclosure. The aforementioned storage media includes U disk, mobile hard disk, Read-Only Memory (ROM), Random Access Memory (RAM), magnetic disk or optical disk and other media that can store program codes.

Finally, it should be explained that the above-mentioned embodiments are only specific embodiments of the disclosure, which are used to illustrate the technical scheme of the disclosure, but not to limit it. The protection scope of the disclosure is not limited to this. Although the present disclosure has been described in detail with reference to the foregoing embodiments, it should be understood by ordinary technicians in this field that any person familiar with this technical field can still modify the technical scheme recorded in the foregoing embodiments or easily think of changes, or replace some technical features with equivalents within the technical scope disclosed in this disclosure, and these modifications, changes or replacements do not make the essence of the corresponding technical scheme deviate from the spirit and scope of the technical scheme in this disclosure, and should be included in the protection scope of this disclosure. Therefore, the scope of protection of this disclosure should be based on the scope of protection of the claims.

1. An interactive method, comprising:
receiving query information, wherein the query information comprises description information of a question to be queried;
determining a query result corresponding to the query information, wherein the query result comprises a plurality of results matched with the question to be queried, and any two results among the plurality of results are not related to each other;
receiving a browsing request for a first query result among the query result, displaying content information of the first query result and displaying a jump identifier, wherein the jump identifier is used to jump to a page corresponding to a second query result having a preset positional relationship with the first query result among the query result.

2. The method according to claim 1, wherein the jump identifier comprises a first jump identifier and/or a second jump identifier;
the first jump identifier is used to jump to a page corresponding to a second query result which is located before the first query result and has a preset positional relationship with the first query result among the plurality of results; and
the second jump identifier is used to jump to a page corresponding to a second query result which is located after the first query result and has a preset positional relationship with the first query result among the plurality of results.

3. The method according to claim 1, wherein the displaying the jump identifier comprises:
determining a first display position in a display page of the content information, wherein the first display position comprises a position located in an area below a central axis of the display page; and
displaying a floating jump button at the first display position, wherein the floating jump button is used to indicate a positional relationship between the first query result and the second query result among the plurality of results.

4. The method according to claim 1, wherein the displaying the jump identifier comprises:
displaying a target jump window at a bottom of a display page of the content information; and
displaying target information of the second query result in the target jump window, wherein the target information is used to represent a second key content of the second query result, the second key content is not completely identical to a first key content of the first query result, and the target information comprises at least one of title information, at least part of abstract information and information source.

5. The method according to claim 4, wherein the determining the query result corresponding to the query information comprises:
acquiring initial query results of the query information, wherein the initial query results correspond to at least one category; and
filtering the initial query results of the at least one category based on a content similarity, and determining a filtered result of initial query results of each category as a query result of the category;
wherein the displaying the target information of the second query result in the target jump window comprises: displaying the target information of the second query result in a category to which the first query result belongs or other categories in the target jump window.

6. The method according to claim 3, wherein the displaying the jump identifier comprises:
displaying the jump identifier at a bottom of the display page in a case where it is detected that a web page corresponding to the first query result displayed in the display page has slid to the bottom of the display page.

7. The method according to claim 4, wherein the target jump window comprises an operation identifier for controlling a display state of the target jump window, and the method further comprises:
controlling the target jump window to be folded down to a bottom of the display page in response to a triggering operation for the operation identifier; and
hiding the target information displayed in the target jump window, and switching a display state of the operation identifier to a preset state, wherein the operation identifier in the preset state is used for triggering to restore the target jump window to a unfold state on a display interface.

8. The method according to claim 3, wherein the displaying the jump identifier comprises:
acquiring a field content of a display field of the jump identifier, wherein the field content is used for indicating whether the jump identifier meets a display condition for displaying on the display page; and
displaying the jump identifier at a bottom of a display page of the content information in a case where it is determined that the jump identifier meets the display condition based on the field content.

9. The method according to claim 1, further comprising:
receiving a triggering operation for the jump identifier; and
determining a page jump link corresponding to the jump identifier, and jumping to a page corresponding to the page jump link.

10. The method according to claim 1, wherein the determining the query result corresponding to the query information comprises:
determining a query keyword in the query information, wherein the query keyword comprises a keyword associated with the question to be queried in the query information;
querying initial query results matched with the query keyword in a network resource; and
filtering the initial query results based on a result relevance between the initial query results to obtain the query result.

11. The method according to claim 10, wherein the filtering the initial query results based on the result relevance between the initial query results to obtain the query result comprises:
extracting key information from each initial query result based on the query keyword, wherein the key information comprises a query abstract and/or a query title;
determining a result similarity between any two initial query results based on key information of the any two initial query results; and
performing de-duplication processing on initial query results with the result similarity being greater than a preset threshold, and obtaining the query result after the de-duplication processing.

12. An interactive apparatus, comprising:
a receiving unit, configured to receive query information, wherein the query information comprises description information of a question to be queried;
a determining unit, configured to determine a query result corresponding to the query information, wherein the query result comprises a plurality of results matched with the question to be queried, and any two results among the plurality of results are not related to each other;
a displaying unit, configured to receive a browsing request for a first query result among the query result, display content information of the first query result, and display a jump identifier, wherein the jump identifier is used to jump to a page corresponding to a second query result having a preset positional relationship with the first query result among the query result.

13. A computer device, comprising a processor, a memory and a bus, wherein the memory stores machine-readable instructions executable by the processor, the processor communicates with the memory through the bus when the computer device is running, and when the machine-readable instructions are executed by the processor, the interactive method according to claim 1 is executed.

14. A computer-readable storage medium, wherein a computer program is stored on the computer-readable storage medium, and the computer program, when executed by a processor, executes an interactive method, and the interactive method comprises:
receiving query information, wherein the query information comprises description information of a question to be queried;
determining a query result corresponding to the query information, wherein the query result comprises a plurality of results matched with the question to be queried, and any two results among the plurality of results are not related to each other;
receiving a browsing request for a first query result among the query result, displaying content information of the first query result and displaying a jump identifier, wherein the jump identifier is used to jump to a page corresponding to a second query result having a preset positional relationship with the first query result among the query result.

15. (canceled)

16. A computer program, wherein the computer program, when executed by a processor, executes the interactive method according to claim 1.

17. The interactive apparatus according to claim 12, wherein the jump identifier comprises a first jump identifier and/or a second jump identifier;
the first jump identifier is used to jump to a page corresponding to a second query result which is located before the first query result and has a preset positional relationship with the first query result among the plurality of results; and
the second jump identifier is used to jump to a page corresponding to a second query result which is located after the first query result and has a preset positional relationship with the first query result among the plurality of results.

18. The interactive apparatus according to claim 12, wherein the displaying the jump identifier comprises:
determining a first display position in a display page of the content information, wherein the first display position comprises a position located in an area below a central axis of the display page; and
displaying a floating jump button at the first display position, wherein the floating jump button is used to indicate a positional relationship between the first query result and the second query result among the plurality of results.

19. The interactive apparatus according to claim 12, wherein the displaying the jump identifier comprises:
displaying a target jump window at a bottom of a display page of the content information; and
displaying target information of the second query result in the target jump window, wherein the target information is used to represent a second key content of the second query result, the second key content is not completely identical to a first key content of the first query result, and the target information comprises at least one of title information, at least part of abstract information and information source.

20. The interactive apparatus according to claim 19, wherein the determining the query result corresponding to the query information comprises:
acquiring initial query results of the query information, wherein the initial query results correspond to at least one category; and
filtering the initial query results of the at least one category based on a content similarity, and determining a filtered result of initial query results of each category as a query result of the category;
wherein the displaying the target information of the second query result in the target jump window comprises: displaying the target information of the second query result in a category to which the first query result belongs or other categories in the target jump window.

21. The interactive apparatus according to claim 18, wherein the displaying the jump identifier comprises:
displaying the jump identifier at a bottom of the display page in a case where it is detected that a web page corresponding to the first query result displayed in the display page has slid to the bottom of the display page.
